(19) United States
(12) Patent Application Publication
(10) Pub. No.: US 2004/0215608 A1
(43) Pub. Date: Oct. 28, 2004

(54) Search engine supplemented with URL's that provide access to the search results from predefined search queries

(76) Inventor: Alastair Gourlay, Boulder Creek, CA (US)

Correspondence Address: STEVEN S. RUBIN, BROWN RAYSMAN MILLSTEIN FELDER & STEINER LLP, 900 THIRD AVENUE, NEW YORK, NY, 10022, US

(21) Appl. No.: 10/424,172

(22) Filed: Apr. 25, 2003

(51) Int. Cl. G06F 7/00

(52) U.S. Cl. 707/3

(57) ABSTRACT

The present invention provides a new method of creating and distributing a customized query. A first user first submits a first query comprising a plurality of query terms and display options to a search engine through a user interface. Based on the query results returned from the search engine, the user can further modify his input. The search engine constructs a first URL in response to the first query. A second user who receives the first URL can search within the query results by refining the first query. The second user can also create a second query through modifying the first query according to his preferences, and then pass a second URL constructed by the search engine to another user.

### FIELD OF THE INVENTION

The present invention relates to the field of search engines, and more specifically relates to systems and methods for creating and distributing a predefined search query in response to a first user's commands, and then refining the query in response to a second user's commands.

### BACKGROUND OF THE INVENTION

The Internet provides a powerful but convenient platform for people to collect and exchange information. For instance, a healthcare organization may set up a website providing state of the art information on a particular type of heart disease. An individual, as a hobby, may build a homepage providing information on a topic of interest, e.g., wind surfing. Each website or homepage is identified by a unique universal resource locator (URL). In order to get the desired information, an average user only needs to know a particular website's URL and have access to a computer that has a browser application and a network connection to Internet.

On many occasions, however, it is not trivial to know which website or homepage contains the desired information on a particular topic. Therefore, people have developed powerful search engines to help Internet users find information in response to search queries.

As a first step of searching for a piece of desired information through a search engine, a user submits a search query on a topic to the search engine. The search query explicitly or implicitly identifies a set of query terms to be searched. The search engine processes the query by matching the query terms with records stored in a database, and furthermore by ranking the documents corresponding to those records according to their relevance to the query terms. The search engine then creates a ranked list of records (e.g., records whose rankings are above a predefined level, or the N highest ranked records), commonly referred to as the “query results”, and returns the query results to the user who submitted the query. The user may either visit a website identified in the query results by clicking the website link embedded in the query results, or may submit a new query to the search engine for a new search.

Even with the help of search engines, locating a piece of desired information accurately and efficiently is not an easy task. Some search tasks, while efficiently performed by experienced search engine users, require numerous attempts and consume significant amounts of time for less inexperienced users. Sometimes, it may even take an experienced user a significant amount of effort to craft a complex query in order to get the desired information from a search engine. As a result, it would be desirable to have a mechanism for preserving search queries (e.g., a search query developed and tested by an experienced user) and for sharing such queries with others.

At present, there is only one easily available mechanism for distributing a search query from one user to other users. When an Internet search query (i.e., a search for documents on the world wide web) is submitted to a search engine, the search is submitted to the search engine as a URL. This URL is typically displayed in the address toolbar of the user's browser. A user can copy the URL from the address toolbar into an email message or other document (e.g., an ordinary word processor document) and can then send that message or document to other users by e-mail. Those other users can re-run the same search by either “clicking” on the URL in the message or document, or equivalently by copying (sometimes called pasting) the URL from the message or document into the address toolbar of their browsers. This methodology of distributing a search query, while workable, is limited in its benefits. In particular, this methodology does not have the ease of use and aesthetic benefits of an ordinary homepage. Users of the methodology describe above will need more than the ordinary level of sophistication to search within the results of the distributed search query. Also, URL representing the search may be very long, and therefore the email or document containing that URL will appear to be complex and intimidating to ordinary users.

As mentioned before, an Internet user may create a homepage to assemble all the relevant information on a topic collected from Internet, and then disseminate the URL of the homepage to anyone he knows who shares the same interest. However, maintaining such homepage is often burdensome and tiresome. In addition, a visitor to the homepage has no control over its content and appearance and cannot easily produce a modified homepage that would better meet the visitor's needs.

### SUMMARY OF THE INVENTION

The present invention provides a new method for creating and distributing a customized search query. A first user submits a first query comprising a set of query terms and a first display form comprising a set of display options to a search engine. During this process the search engine provides at least one temporary query result to the first user in response to the first user's query terms and display options. The first user can adjust his query terms and display options accordingly to produce query results more to his liking. The search engine finally constructs a URL incorporating the first search query and the first display form, and returns the URL to the first user. The first user then sends the URL to a second user.

Upon activation of the URL by the second user, the search engine retrieves a set of query results (e.g., representing documents available from the Internet) in response to the first query and displays the query results to the second user according to the first display form specified by the first user. The first display form includes a window for receiving a query refinement from the second user.

The second user provides a query refinement in the window and submits a second query to the search engine. The second query comprises the first search query and the query refinement. Every search query submitted to the search engine triggers the search engine to process that new query and to return a corresponding set of search results. Therefore, every search query receives dynamic and updated results.

The second user can also modify the first query and the first display form, and submit a third query and a second display form to the search engine. The search engine constructs a second URL incorporating the third search query and the second display form, and returns the second URL to the second user.

In a first preferred embodiment of the present invention, the search engine constructs a URL containing all the query terms and display options specified by a user, and returns the URL to the user. The search engine does not store the URL in its memory. Upon activation of such URL, the search engine directly launches the query over Internet without any pre-processing.

In a second preferred embodiment of the present invention, the search engine generates a unique query identifier for a search query incorporating all the query terms and display options specified by a user, and stores both the query identifier and the query in its memory. The search engine then returns a unique URL containing the query identifier to the user. Upon activation of such URL, the search engine replaces the query identifier with the search query stored in its memory and launches the query accordingly.

### BRIEF DESCRIPTION OF THE DRAWINGS

FIG. 1 is a flow chart demonstrating how a user creates a customized query and its corresponding URL that incorporates the user's query terms and display options.

FIG. 2 illustrates a user interface allowing a user to input the query terms, specify the display options, and preview the query results.

FIG. 3 illustrates a webpage of query results in response to the user's commands.

FIG. 4 is a flow chart demonstrating how a second user modifies an existing query and creates a new query and new URL that incorporate a new set of query terms and display options.

FIG. 5 is a block diagram of a search engine server.

FIG. 6A illustrates a client computer submitting a query to a search engine according to a first preferred embodiment of the present invention.

FIG. 6B illustrates a client computer submitting a query to a search engine according to a second preferred embodiment of the present invention.

Like reference numerals refer to corresponding parts throughout the several views of the drawings.

### DESCRIPTION OF THE PREFERRED EMBODIMENTS

As discussed above, a homepage may be used to gather information on a particular topic. One approach of implementing such a homepage would be to physically store all the information for the homepage on a single computer system.

The present invention provides a different view of a homepage for gathering information on a particular topic. In the context of the present invention, a homepage is a mechanism for displaying dynamically generated query results from a search query submitted to a search engine, in accordance with display options specified by (or corresponding to) the homepage's URL. The search query can be complex and the homepage includes a “search within” window for the user to submit additional query terms. When terms are entered into the “search within” window by a user, a search is performed that identifies a subset of the documents identified by the original search query for the homepage. The homepage creator is only responsible for specifying query terms and display options. The search engine generates a URL in response to the creator's input and the search engine also updates (or dynamically generates) the content of the homepage each time a user views the homepage in a browser. Any user who has access to the URL can take advantage of the complex query represented by the URL without having to recreate it. Furthermore, any user can modify the query and generate a new URL in response to his own query terms and display options.

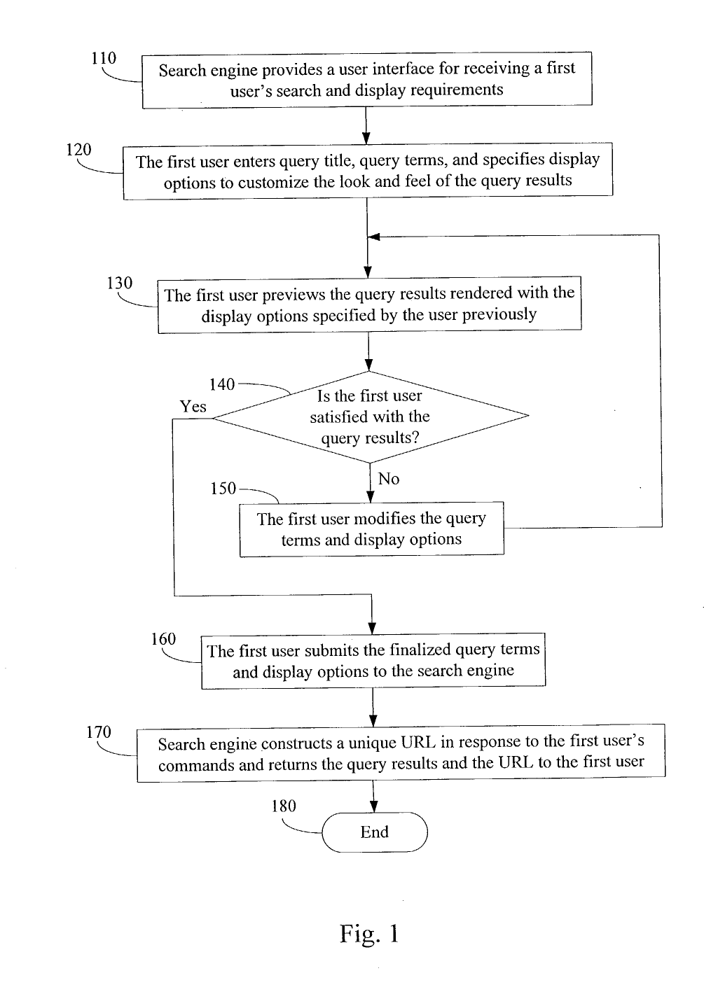

FIG. 1 illustrates a typical process of constructing a customized query in response to a user's query terms and display options according to one embodiment of the present invention.

In step 110, a search engine provides a user interface for receiving from a first user a plurality of query terms and display options. The user interface is typically generated by a search engine server computer and is viewed in a browser window of a client computer system. A query term can be a single word or a phrase having multiple words regarding a particular topic. More generally, the search query specified using the user interface can include a Boolean combination of query terms, as well as a set of display options. A display option determines the appearance of the query results, such as whether the query results include images.

In step 120, the first user enters a query title and query terms, and specifies display options to customize the look and feel of the query results. In one embodiment, the query terms are divided into three sets: a first set comprises terms that are required to be included in the query results; a second set comprises terms that are optional and preferred for inclusion in the query results; and a third set comprises terms that are not allowed to be included in the query results.

For example, in order to create a webpage with information about surfing activities in the Santa Cruz area of California, the user may choose “surfing”, “Santa Cruz”, and “California” as required query terms. Meanwhile, the user may want to focus the search on those Internet surfing groups and surfing clubs in the same area. Therefore, the terms such as “surfing group” and “surfing club” are appropriate candidates for optional terms. Finally, the term “surfing” is also used in Internet browsing, such as “web surfing” or “Internet surfing”. The user can set these two terms as excluded query terms so as to exclude web pages and other documents from the results of the search query.

In step 130, the first user previews the query results in response to the query terms and display options specified by the user in step 120. Such preview can happen in the same user interface window or in a separate window.

In step 140, if the user is not satisfied with the query results and/or with the look and feel of the webpage, he can modify the query terms and display options in step 150. The user can modify certain query terms to include or exclude certain query results. The user can also adjust the display options to personalize the query results. Steps 130, 140 and 150 form a loop. Note that the user who is defining the search query does not need to know the location of the desired information. He only needs to clarify his search requirements through the user interface.

When the user is satisfied with the webpage, he submits the finalized query terms and display options to the search engine in step 160.

In step 170, upon receiving the finalized query terms and display options, the search engine constructs a unique URL and associates the URL with the first user's search query. Finally, the search engine returns the URL and the query results to the first user.

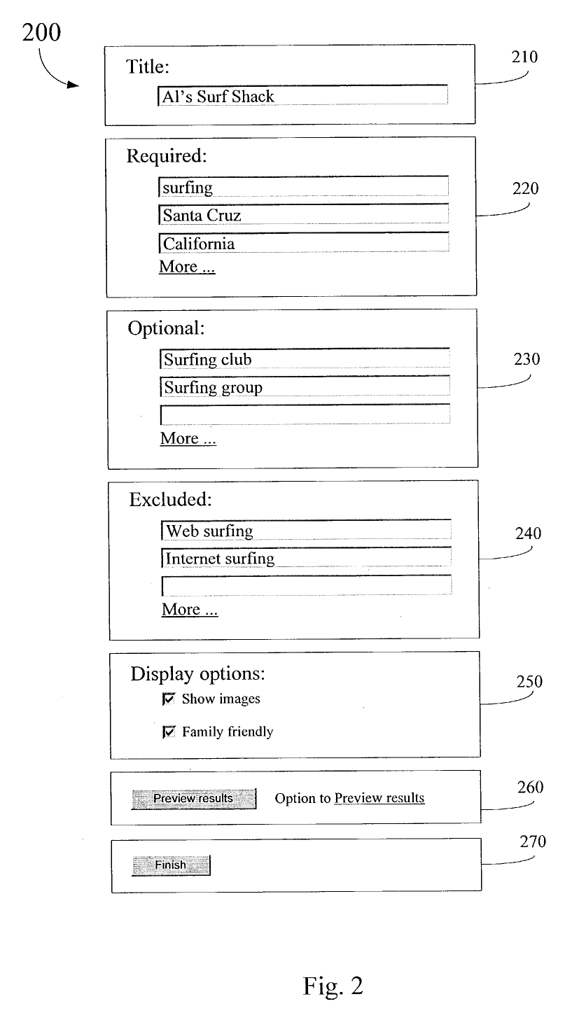

FIG. 2 demonstrates a “query webpage builder” user interface 200 used in one embodiment of the present invention. User interface 200 includes seven exemplary functional areas. Other embodiments may include a subset of these exemplary functional areas and may furthermore include other functional areas. For ease of reference and explanation, each of these functional areas is shown in FIG. 2 in a box. Such arrangement is for an illustrative purposes and it is by no means exhaustive. In box 210, there is an edit field for receiving a title from the user. The title is typically a text string that will be displayed at the top of the form or homepage that will generated for the user. In box 220, there are three edit fields for receiving the query terms that are required to be included in the query results. If the three edit fields are not enough, the user can click the link “More . . . ” in order to bring up a display with room for entering additional required query terms. Similarly, there are three edit fields for receiving terms that are optional and preferred for inclusion in the query results in box 230, and three edit fields for receiving terms that are not allowed to be included in the query results in box 240.

The fields in box 250 provide a plurality of display options to the user, such as a checkbox for showing including images in the search results generated in response to the search query and a checkbox for rendering family-friendly contents only. In box 260, the user can click the button “Preview results” to examine the query results and to review the look and feel of the webpage generated by the query builder module. By doing so, the user can further customize the webpage to fit his needs. Finally, by clicking button “Finish”, the first user submits the search requirements specified in this user interface to a module for generating a URL representing the user specified search query and display options.

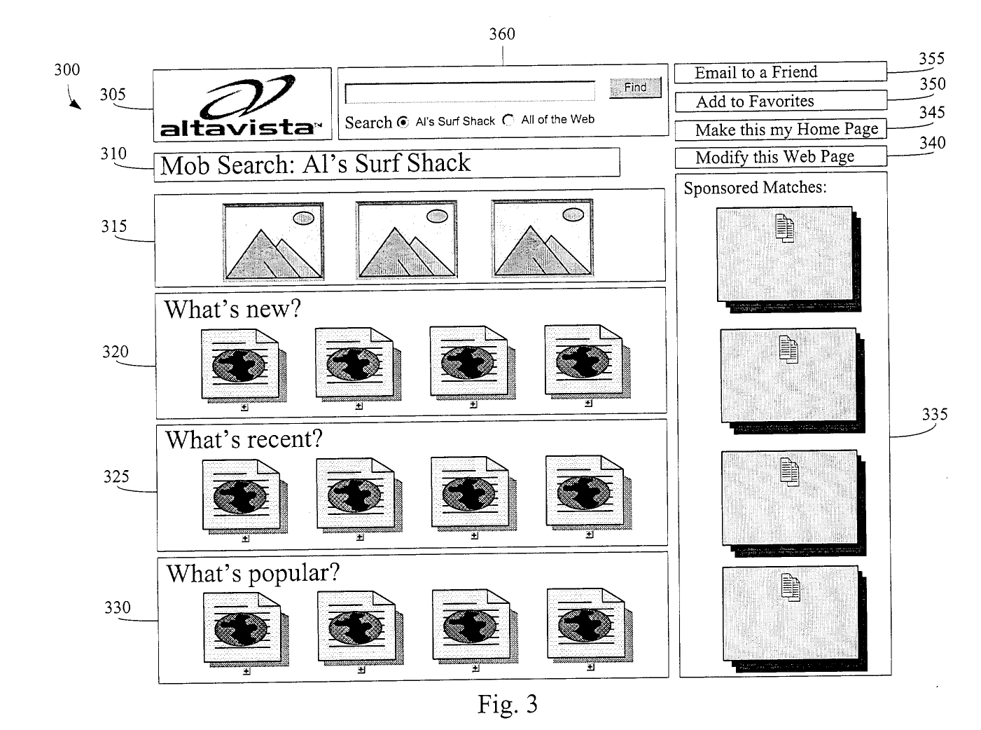

FIG. 3 schematically depicts a webpage 300 that is generated upon activation of a URL created in the process shown in FIG. 1. Box 305 contains an image which can be a search engine's logo, or can be logo specified by the first user, such as a logo associated with the title (box 310). Box 310 contains a title provided by the first user. Below the title is box 315 containing a plurality of images retrieved by the search engine. Each image represents a link to another website that a user can visit them by clicking on the image. These images are from image documents located by the search engine based on the search query embedded in or corresponding to the URL for the webpage. Images are included in the webpage 300 if the first user enables the “display images” display option (see FIG. 2).

The rest of the query results may be divided into functional areas. Box 320 contains a plurality of relevant news with a sub-title “What's new?”. A visitor to this webpage gets a quick update on the topic of interest by skimming the contents in this box. Box 325 contains a plurality of relatively old, but still recent information corresponding to the search query. Box 330 contains the information of popular sub-topics for visitors who are willing to spend more time. To the right is box 335, containing sponsored matches or equivalent commercials, preferably selected either on the basis of the search query, or that have some other relationship to either the topic of interest. Alternately, the items displayed in box 335 may have a commercial or financial relationship with the search engine or the sponsor of the search query webpage.

It should be noted that webpage 300 is only illustrative. In various embodiments the webpage 300 may display query results in many different ways, including both very simple display formats and very sophisticated display formats. There are no fixed rules on how to categorize and display the query results. The appearance of a webpage is dependent upon many factors, such as the first user's preferences, the capability of a search engine, and the characteristics of a topic, etc. In general, the first user can weave the query results into a webpage that is very similar to a conventional homepage through the user interface 200 shown in FIG. 2. A significant advantage of a webpage generated using the present invention over a conventional homepage is that content of the webpage is dynamically updated without requiring further work interference by a human being.

Another important feature of webpage 300 is demonstrated by the search field 360 adjacent to the logo image 305. Any visitor to this webpage can enter additional terms to refine the first query and conduct a new search within the first query results. This feature helps a visitor to search within the first query results with little effort, since the query refinement is based on the first query. It is also noted that in a preferred embodiment, the first query (defined by the first user) is not displayed on webpage 300, thereby allowing average users of the webpage to avoid being exposed to the details of the first query. As explained below, if a user wishes to review and possibly change the details of the first query, he/she clicks on the “Modify this Web Page” button 340, which will bring the user to a user interface such as the one shown in FIG. 2.

As shown in FIG. 3, if the visitor chooses to search within “Al's Surf Shack”, the search engine launches a new query only against the first query results that have been returned by the first query. This characteristic is very attractive to a relatively inexperienced user because he can leverage the first user's search expertise painlessly. If the visitor chooses to search “All of the web”, the search times entered into search field 360 are sent to the search engine, which performs a new search based only on the search terms in search field 360. The results of that search may be displayed on a new webpage, such as the normal webpage produced by the search engine in response to a query submitted through its normal user interface.

Box 355 helps the user to send the unique URL (not shown) associated with webpage 300 to other users. Clicking this box produces an email message containing the webpage's URL. This is accomplished using the normal integration between the browser on the user's computer and an email application on that computer. The user of webpage 300 can add the URL for the webpage 300 to his “favorites” list (also called a bookmarks list) by clicking box 350, and can make this URL his home page by clicking box 345. These boxes (355, 350, 345) all employ mechanisms available in most web browsers, and thus do not require detailed explanation.

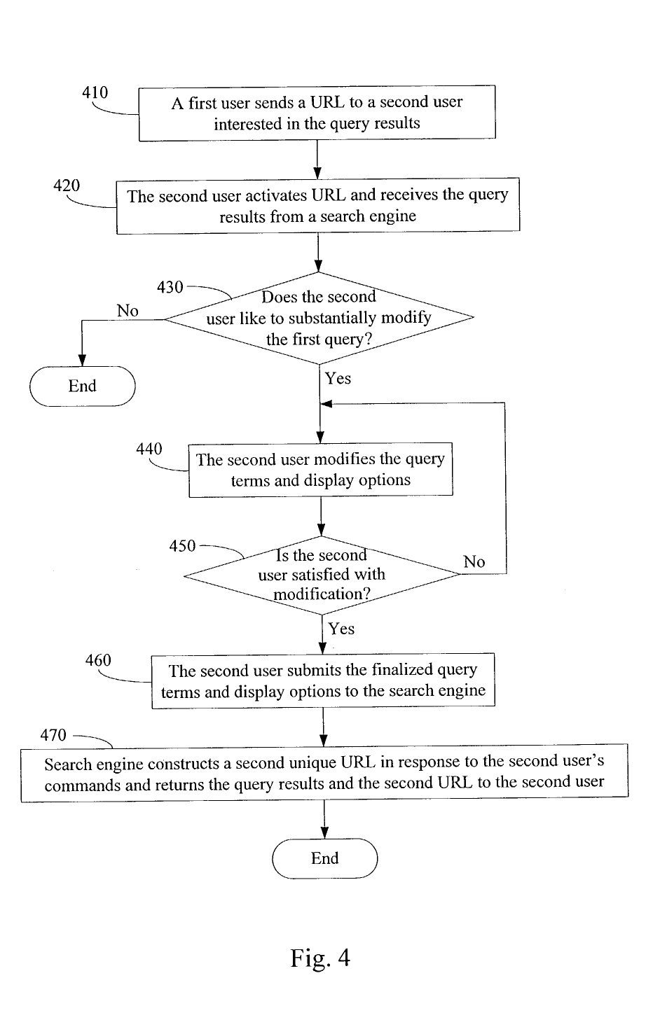

If a second user visiting the webpage 300 is not satisfied with the query refinement option provided in box 360, he may want to substantially modify the first query and construct a new query. For example, the second user may plan to create a second query on a different topic, but may want to keep the look and feel of the first query. Instead of re-building everything from scratch, the second user can click the link “Modify this Web Page” shown in box 340. Referring to FIG. 4, clicking box 340 starts a process that is similar to the process discussed in FIG. 1.

In step 410, a first user sends a URL to a second user. In step 420, upon activation of the URL, the second user receives the query results from the search engine in response to a first query created by the first user. The results are displayed using the display options specified in the URL (e.g., including the title specified by the first user). In step 430, the second user decides whether he/she intends to substantially modify the first user's search or display requirements. If the answer is no, the process stops (e.g., the second user continues viewing or working with the original webpage). If the answer is yes, the second user will visit a user interface similar to FIG. 2 in step 440, where he/she can modify the query terms, change the title, or change the display options. In step 450, the second user may preview the query results in response to the modified query. If the second user is not satisfied with the modification, the process moves back to step 440. If the second user is satisfied with his modification, he can submit the modified query terms and display options to a query building module in step 460. Finally, the query building module constructs a second unique URL and returns it as well as the query results to the second user in step 470.

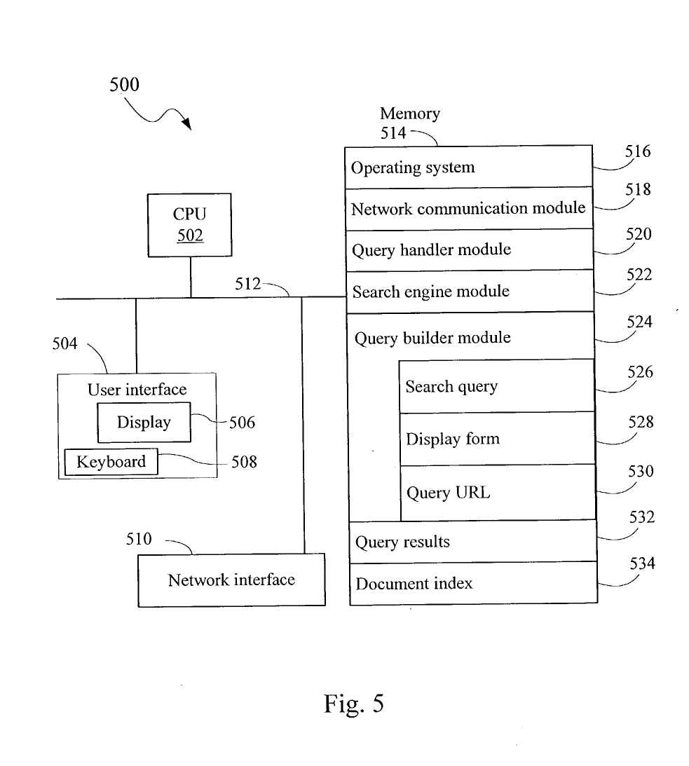

FIG. 5 illustrates a computer system implementing an embodiment of the present invention. A search engine server is implemented using one or more computer systems 500, as schematically shown in FIG. 5. It will be appreciated by those of skill in the art, that search engines designed to process large volumes of queries may use more complicated computer architectures than the one shown in FIG. 5. For instance, a front end set of servers may be used to receive and distribute queries among a set of back end servers that actually process the queries. In such a system, the system 500 shown in FIG. 5 would be one of the back end servers. In yet another embodiment, a server that is separate and distinct from the back end servers that process queries may be used to execute the query builder module 524.

The computer system 500, will typically have one or more processing units (CPU's) 502, a network or other communications interface 510, memory 514, and one or more communication buses 512 for interconnecting the components of the computer system 500. The computer system 500 may optionally include a user interface 504, for example, including a display 506 and a keyboard 508. Memory 514 can include high speed random access memory and can also include non-volatile memory, such as one or more magnetic disk storage devices (not shown). Memory 514 may also include mass storage that is remotely located from the central processing unit(s) 502. The memory 514 preferably stores:

an operating system 516 that includes procedures for handling various basic system services and for performing hardware dependent tasks;

a network communication module 518 that is used for connecting the system 500 to various client computers (not shown) and possibly to other servers or computers via one or more communication networks (wired or wireless), such as the Internet, other wide area networks, local area networks, metropolitan area networks, and so on;

a query handler module 520 for receiving a query from a client computer;

a search engine module 522 for searching a document index 534 for documents related to a query and for forming query results 532;

a query builder module 524;

query results 532, representing the results generated by the search engine module 522 in response to a search query; and

a document index 534 used by the search engine module 522 to identify documents that satisfy a search query.

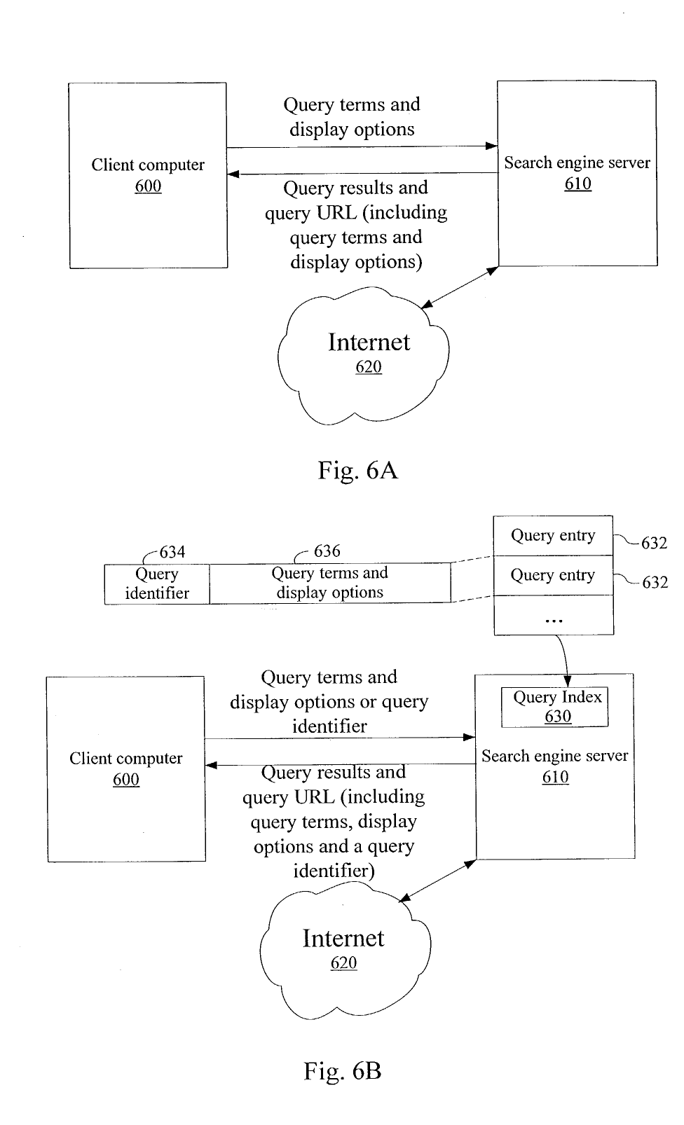

Of course, the memory 514 of the server 500 may store many other procedures and data structures. Only the procedures/modules and data structures relevant to the present discussion are shown in FIG. 5. As discussed below with reference to FIG. 6B, in one embodiment the memory 514 of the server 500 also stores a query index 630, which retains information about search queries defined by users using the query builder module 524.

Query builder module 524 includes executable procedures, sub-modules, tables and other data structures. In one embodiment, the query builder module includes:

a search query sub-module 526 for analyzing the query terms submitted by a user and constructing an efficient search query;

a display form sub-module 528 for interpreting the display options submitted by the user and presenting query results 532 in a user-specified manner; and

a query URL sub-module 530 for constructing a URL incorporating query terms, display options, and query results in response to the user's commands.

The URL constructed by query builder 524 is used by the browser of a user's computer to submit a search query and a set of display options to a search engine.

The more information a URL carries, the longer the URL. However, there is a limitation to the length of a URL, currently (circa 2003) 4K bytes. This limitation may become a problem if, for instance, the query builder module 524 and the “query webpage builder” user interface 200 are modified to enable the first user to specify a document to be displayed as the background of the query webpage, or to be displayed within a particular region of the query webpage being defined by the first user. The content of the document would ideally be included in the URL, so as to always be available to any user of the URL. However, this might violate the 4 k byte size limitation on URL's. The following discussion explains at least one methodology and mechanism for overcoming the URL length limitation.

In a first embodiment shown in FIG. 6A, a URL is constructed dynamically as explained above. In this embodiment, a first user uses the query webpage builder interface 200 (FIG. 2) of the query builder module 524 (FIG. 5) to specify the query terms and display options of a query webpage. The query builder module 524 submits the query to a search engine, so as to generate query results, and also constructs a URL that incorporates the query terms and display options. The server that incorporates the query builder module (which may or may not be the same server as the search engine server) returns the URL to the client computer. If a user (e.g., either the first user or a second user) submits a query refinement, a new query submitted to the search engine includes both the original query and the query refinement since the search engine does not keep a copy of the original query.

However, if a user needs more control over the query results, e.g., a user may want to attach an image to the query (e.g., a logo to be displayed adjacent the title), for the sake of implementation and efficiency, the user input may be stored in the search engine server's hardware.

In a second embodiment of the present invention shown in FIG. 6B, in addition to the components disclosed in FIG. 5, a search engine server 610 also includes a query index 630. In this embodiment, a user (using client computer 600) uses the query builder module 524 (FIG. 5) to submit a query containing the query terms and display options to the search engine server 610 (or to another server, such as a server on which the query builder module 524 resides). If this is the first time such a query is submitted to the search engine, the search engine generates a new entry in its query index 630. An entry 632 in the query index 630 comprises a unique query identifier 634 and the corresponding query terms and display options 636. If the user who is defining the new query submits a document to be displayed on the query form, that document is treated as part of query terms and display options 626, and is saved in the search engine server 610. The search engine server then launches a query based on the query terms and retrieves query results using its document index 534 and search engine module 522. In this case the URL generated by the form for the second user to submit to the search engine may have the form:

http://mob.altavista.com/mob?QueryID%AddedQueryParams

where “mob.altavista.com” is the Internet address for submitting to the search engine queries having specified display options or a specified display form, QueryID represents the query identifier, and AddedQueryParams represents the added query terms provided by the second user. An example of such a URL is:

http://mob.altavista.com/mob?id=Als_Surf_Shack&query=wetsuits

The search engine constructs a URL incorporating only the unique query identifier, and returns the URL to the client computer 600. This URL is very short and thus costs less to transmit, and more importantly will always be shorter than the URL size limit. When another user activates this URL (e.g., by clicking on a link containing the URL), the search engine will search the query index 630 for a query entry 632 having the query identifier in the URL. It will then send the query terms and display options stored in the query entry 632 for the submitted URL to the search engine module 622. If a second user submits a modified query to the search engine (e.g., having modified query terms and/or display terms), along with a command to generate a new query search form, the search engine will generate a new query entry 632 in the query index 630. The new query entry will having a new, unique query identifier for the modified query. However, if a second user simply resubmits a previously defined query with additional query terms, using the “search within” feature of the previously defined query form, then the URL representing the new query will be submitted to the search engine without generating a new query index entry.

In another embodiment, the URL for each defined query is not stored in a query index. Instead, each such URL is compressed and optionally may be encrypted as well. The URL is compressed using any of a number of well known compression methods. Compressing the URL helps to avoid the URL from exceeding the URL size limit, and makes it easier to incorporate URL's representing complex queries into documents and messages. Encrypting the URL, which is optional, helps to make the underlying implementation less visible to the end user, which may discourage uninformed or malicious modification of the URL.

The present invention can be implemented as a computer program product that comprises a computer program mechanism embedded in a computer readable storage medium. This computer program product can be stored on a CD-ROM, magnetic disk storage product, or any other computer readable data or program storage product. The software modules in the computer program product may also be distributed electronically, via Internet or otherwise, by transmission of a computer data signal (in which the software modules are embedded) on a carrier wave.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed is:

1. A method of creating and distributing a customized search query, comprising:
in response to a first user's commands, defining a first search query;
constructing a URL that has associated therewith the first search query and a display form for displaying search results generated using the first search query;
sending the URL to a second user;
upon activation of the URL by the second user,
submitting the first search query to a search engine;
displaying query results received from the search engine within the display form incorporated in the URL;
displaying a window for receiving a query refinement; and
upon entry of a query refinement by the second user, submitting a second query to the search engine, the second query comprising the first search query combined with the query refinement.

2. The method of claim 1, wherein the URL incorporates data representing the first search query and specifying the display form.

3. The method of claim 1, wherein the first search query comprises a first set of terms that are required to be included in the query results, a second set of terms that are optional and preferred for inclusion in the query results, and a third set of terms that are not allowed to be included in the query results.

4. The method of claim 1, wherein specifying a display form includes specifying a title to be displayed in the form and specifying a document to be at least partially displayed in the form.

5. The method of claim 1, wherein specifying a display form includes specifying a title to be displayed in the form and specifying image data to be displayed in the form when the form is viewed on a client computer.

6. The method of claim 1, wherein defining a first search query includes:
defining a trial search query;
submitting the trial search query to the search engine;
displaying trial query results received from the search engine;
displaying with the trial query results positive and negative feedback links; and
in response to user selection of one or more of the feedback links, generating a revised version of the trial search query so as to produce the first search query.

7. The method of claim 1, wherein defining a first search query includes:
defining a trial search query;
submitting the trial search query to the search engine;
displaying trial query results received from the search engine;
receiving user feedback concerning the trial query results, and
based on the user feedback, generating a revised version of the trial search query so as to produce the first search query.

8. The method of claim 1, wherein the URL includes a fixed-length, unique identifier which is communicated to the search engine upon activation of the URL by the second user so as to submit the first search query or the second search query to the search engine.

9. A search engine system, comprising
one or more central processing units for executing programs;
a document index identifying documents;
a search engine module, executable by the one or more central processing units, for identifying documents in the document index in response to a specified first search query;
a builder module for defining a first search query in response to a first user's commands, constructing a URL that has associated therewith the first search query and a display form for displaying search results generated using the first search query;
the display form including a window for receiving and displaying a query refinement, and for submitting to the search engine a second query, the second query comprising the first search query combined with the query refinement; and
the display form further including a results window for displaying results produced by the search engine in response to the first or second query.

10. The search engine system of claim 9, wherein the URL incorporates data representing the first search query and specifying the display form.

11. The search engine system of claim 9, wherein the first search query comprises a first set of terms that are required to be included in the query results, a second set of terms that are optional and preferred for inclusion in the query results, and a third set of terms that are not allowed to be included in the query results.

12. The search engine system of claim 9, wherein specifying a display form includes specifying a title to be displayed in the form and specifying a document to be at least partially displayed in the form.

13. The search engine system of claim 9, wherein specifying a display form includes specifying a title to be displayed in the form and specifying image data to be displayed in the form when the form is viewed on a client computer.

14. The search engine system of claim 9, wherein defining a first search query includes:
defining a trial search query;
submitting the trial search query to the search engine;
displaying trial query results received from the search engine;
displaying with the trial query results positive and negative feedback links; and
in response to user selection of one or more of the feedback links, generating a revised version of the trial search query so as to produce the first search query.

15. The search engine system of claim 9, wherein defining a first search query includes:
defining a trial search query;
submitting the trial search query to the search engine;
displaying trial query results received from the search engine;
receiving user feedback concerning the trial query results, and
based on the user feedback, generating a revised version of the trial search query so as to produce the first search query.

16. The search engine system of claim 9, wherein the URL includes a fixed-length, unique identifier which is communicated to the search engine upon activation of the URL by the second user so as to submit the first search query or the second search query to the search engine.
